(19) United States
(12) Patent Application Publication
(10) Pub. No.: US 2005/0069455 A1
(43) Pub. Date: Mar. 31, 2005

(54) Chemical analyzer for sulfur

(75) Inventors: Stephen T. Staphanos, Long Beach, CA (US); Marion A. Keyes, St. Louis, MO (US)

Correspondence Address: David C. Bohn;Westman, Champlin & Kelly, Suite 1600, 900 Second Avenue South, Minneapolis, MN, 55402-3319, US

(73) Assignee: Rosemount Analytical Inc., Anaheim, CA (US)

(21) Appl. No.: 10/675,018

(22) Filed: Sep. 30, 2003

(51) Int. Cl. G01N 31/12

(52) U.S. Cl. 422/78; 436/119

(57) ABSTRACT

A circulating flow of liquid gasoline is provided to a chemical analyzer for analyzing sulfur concentration. The chemical analyzer vaporizes and combusts a sample of the gasoline to provide an exhaust gas that includes sulfur dioxide produced by combusting the sulfur concentration. The exhaust gas is pressurized and delivered to a flame photometric detector which detects the sulfur dioxide concentration. The sulfur content is inferred from the sulfur dioxide concentration.

### BACKGROUND OF THE INVENTION

Crude oil typically includes various sulfur compounds ranging from about 0.2% to 3% by weight sulfur content. As crude oil is refined to make gasoline, the sulfur content is reduced in order to produce gasoline that will burn cleanly with low levels of pollution needed to meet clear air requirements.

The refining process can be adjusted to control the sulfur content of the gasoline, however, this control is somewhat inexact because of the large time delays involved in collecting a sample, transporting it to a laboratory, performing a laboratory analysis and returning data on sulfur content to the refinery operator.

A method and apparatus are needed to provide real time, on-line data of sulfur content in gasoline for control of refinery processes.

### SUMMARY OF THE INVENTION

Disclosed are a chemical analyzer and method of chemical analysis of sulfur concentration. The chemical analyzer comprises a flow restrictor. The flow restrictor receives a circulating liquid flow comprising a sulfur concentration. The flow restrictor has a flow restrictor outlet that provides a liquid sample flow that is a portion of the circulating liquid flow.

A vaporizer receives the liquid sample flow. The vaporizer provides a vaporized sample flow that includes a portion of the liquid sample flow.

A combustion chamber receives the vaporized sample flow and also receiving supplies of air and a fuel gas. The combustion chamber provides a combustion exhaust gas in which the sulfur concentration is combusted to sulfur dioxide.

A pump receives the combustion exhaust gas at an inlet pressure. The pump provides pressurized combustion exhaust gas at a pressure that is higher than the inlet pressure.

A flame photometric detector receives the pressurized combustion exhaust gas. The flame photometric detector provides a chemical analysis output indicative of the sulfur concentration in the circulating liquid flow.

### BRIEF DESCRIPTION OF THE DRAWINGS

FIG. 1 illustrates a first embodiment of a chemical analyzer.

FIG. 2 illustrates a second embodiment of a chemical analyzer.

FIGS. 3A, 3B, 3C, 3D together illustrate a third embodiment of a chemical analyzer.

### DETAILED DESCRIPTION OF THE PREFERRED EMBODIMENTS

In the embodiments described below, a circulating flow of liquid gasoline is provided to an on-line chemical analyzer for analyzing sulfur concentration. The circulation of the flow ensures that real time samples are being analyzed by the analyzer. The chemical analyzer vaporizes and combusts a sample of the gasoline to provide an exhaust gas that includes sulfur dioxide produced by combusting the sulfur concentration. The exhaust gas is pressurized and delivered to a flame photometric detector which detects the sulfur dioxide concentration. The sulfur content is then inferred from the sulfur dioxide concentration. The chemical analyzer provides a real time output representing the sulfur content of the gasoline. The output can be coupled to a readout or used to control a refinery process to reduce sulfur content to an acceptable level.

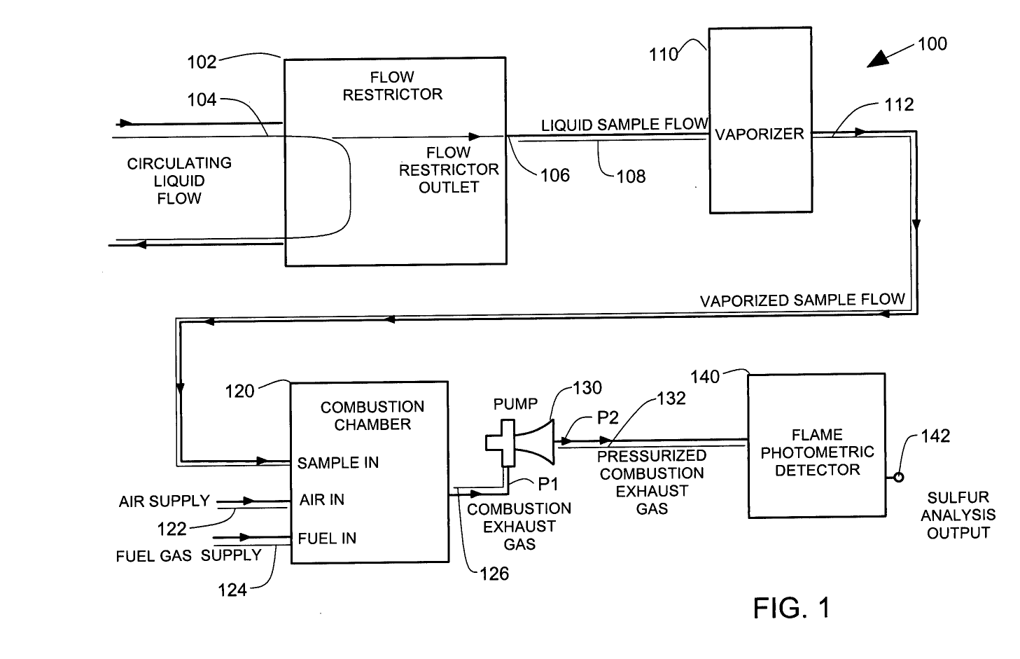

FIG. 1 illustrates a first embodiment of a chemical analyzer 100. Tubing is indicated by relatively thicker lines connecting various components together, and fluid flow inside the tubing is indicated by relatively thinner lines alongside such tubing.

The chemical analyzer 100, comprises a flow restrictor 102 receiving a circulating liquid flow 104 comprising a sulfur concentration. The flow restrictor 102 has a flow restrictor outlet 106 providing a liquid sample flow 108 that is a portion of the circulating liquid flow 104.

The chemical analyzer 100 comprises a vaporizer 110. The vaporizer 110 receives the liquid sample flow 108. The vaporizer 110 provides a vaporized sample flow 112 that includes a vaporized portion of the liquid sample flow 108.

The chemical analyzer 100 comprises a combustion chamber 120 that receives the vaporized sample flow 112 and also receive a supply of air 122 and a supply of fuel gas 124. The combustion chamber 120 provides a combustion exhaust gas 126 in which the sulfur concentration in the vaporized sample flow 112 is combusted to produce sulfur dioxide.

The chemical analyzer 100 includes a pump 130. The pump 130 receives the combustion exhaust gas 126 at a pump inlet pressure P1 and provides pressurized combustion exhaust gas 132 at a pump outlet pressure P2 that is higher than the inlet pressure P1.

The chemical analyzer 100 includes a flame photometric detector 140. The flame photometric detector 140 receives the pressurized combustion exhaust gas 132 and provides a chemical analysis output 142 indicative of the sulfur concentration in the circulating liquid flow.

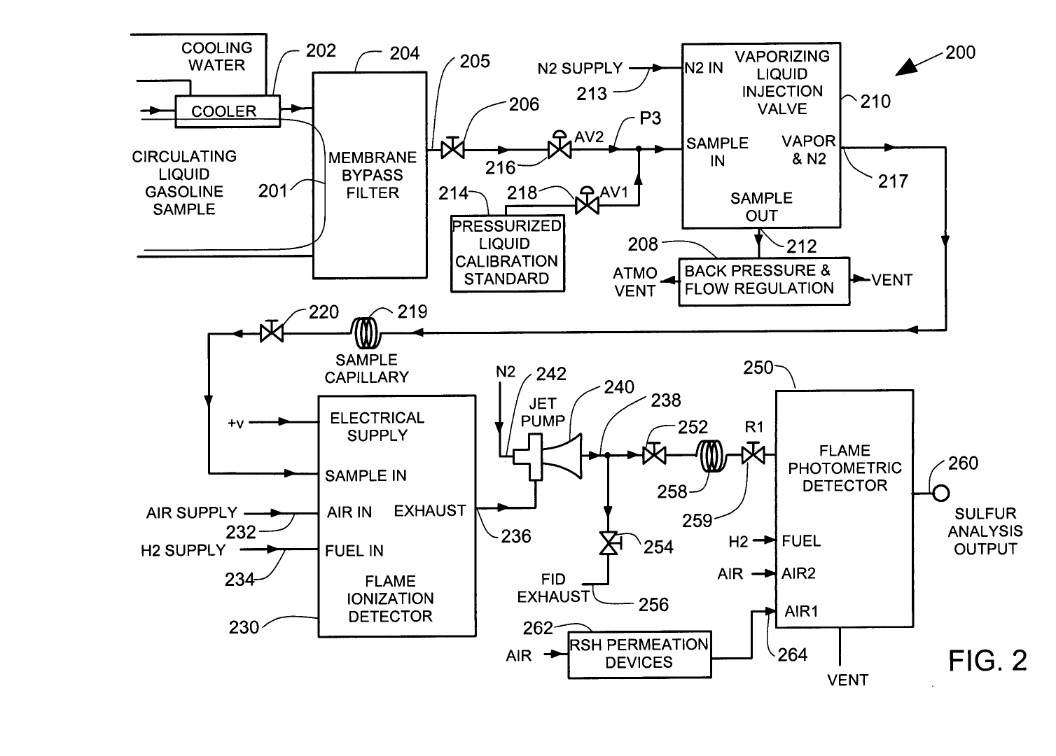

The chemical analyzer 100 is typically mounted in the field near a piping system that carries a liquid such a gasoline that has trace quantities of sulfur. A small sample of the liquid gasoline flow is heated and vaporized in vaporizer 112. The vaporized gasoline is burned in combustion chamber 120, and the burning converts the sulfur to sulfur dioxide in the exhaust 126 of the combustion chamber. The exhaust 126 of the combustion chamber is passed through the pump 130 in order to increase pressurization. The pressurized exhaust 132 is fed into a flame photometric detector 140 which measures the sulfur dioxide content. Through a calibration process, the concentration of the sulfur in the gasoline is inferred from the sulfur dioxide content measured by the flame photometric detector 140. The measurement process is performed quickly in order to provide a real time output that is useful for controlling the process of manufacturing the gasoline in order to control sulfur content to an acceptable level. The operation of the chemical analyzer 100 is explained in more detail below by way of an example illustrated in FIG. 2.

FIG. 2 illustrates a second embodiment of a chemical analyzer 200. In FIG. 2, a liquid gasoline sample 201 is circulated through a cooler 202 and a membrane bypass filter 204. The liquid gasoline sample is received at a temperature of 40 to 400 degrees F. and a pressure of 30 to 500 PSIG pressure and a flow rate of about 0.5 gallon per minute. Water circulates through the cooler 202 to maintain a temperature at less than 250 degrees F. in the membrane bypass filter 204. The relatively high flow rate of 0.5 gallon per minute is maintained in order to reduce lag time for sensing changed in the sulfur concentration.

The membrane bypass filter 204 has a pore size of about one micron and functions as a flow restrictor to provide a lower volumetric flow rate sample flow 205 to a vaporizing liquid injection valve 210. The lower volumetric flow rate is controlled by regulating valve 206 and a back pressure and flow regulation system 208 connected to a sample outlet 212 of the vaporizing liquid injection valve 210. The flow regulation system 208 preferably includes a back pressure regulator valve and a 10 scc per minute flow regulation valve (not illustrated in FIG. 2). A back pressure P3 is maintained above a bubble point pressure. In a preferred arrangement, the analyzer can be calibrated using a pressurized liquid calibration standard 214. Valves 216, 218 can be actuated to select either the calibration standard 214 or the sample flow 205 as an input to the vaporizing liquid injection valve 210. The vaporizing liquid injection valve 210 also receives a supply of nitrogen 213 as a carrier gas.

The vaporizing liquid injection valve 210 vaporizes the received sample flow 205 (or calibration standard 214). The vaporizing liquid injection valve 210 mixes vapor from the sample flow 205 (or calibration standard 214) with nitrogen and provides a gaseous sample output 217. The vaporizing liquid injection valve is preferably a dual zone valve that is maintained at about 225 degrees centigrade. The gaseous sample output 217 is passed through a sample capillary 219 and a regulating valve 220 and then supplied as a sample to a flame ionization detector 23Q.

The flame ionization detector 230 receives a supply of air 232, a supply of H₂ fuel 234, and burns the gaseous sample, converting the sample to a mixture of sulfur dioxide, CO₂ and H₂O at the exhaust 236 of the flame ionization detector 230. The flame ionization detector 230 is maintained at about 225 degrees C. The exhaust 236 of the flame ionization detector is its useful output in this application. An electrical output of the flame ionization detector need not be used.

The exhaust 236 of the flame ionization detector 230, which contains sulfur dioxide, is drawn into a jet pump 240. The jet pump 240 mixes the exhaust 236 with a stream of nitrogen 242 in the jet pump 240. The mixture of nitrogen and exhaust 236 (which includes sulfur dioxide) is provided as a sample flow 238 to a flame photometric detector 250. The jet pump 240 is controlled by a flow controller (not illustrated in FIG. 2) and provides a pressurized sample flow that includes N₂ gas mixed with the exhaust 236. valves 252, 254 are provided so that the sample flow 238 can be temporarily diverted to an exhaust outlet 256 during calibration of the flame photometric detector 250. A capillary 258 and a regulating valve 259 control flow into the flame photometric detector 250.

The flame photometric detector 250 detects the sulfur dioxide in the sample flow 238. The flame photometric detector 250 provides an electrical output 260 representative of the sulfur content of the liquid gasoline sample as inferred from the measured sulfur dioxide content in the sample flow 238. In a preferred arrangement, the flame photometric detector 250 is maintained at about 225 degrees C. In a preferred embodiment, the sensitivity to sulfur dioxide of the flame photometric detector 250 is increased by providing a stream of air and RSH (mercaptans) from RSH permeation devices 262 to an air inlet 264 on the flame photometric detector 250. A cycle time for completing a measurement is less than 60 seconds. Total sulfur can be measured in ranges between 0-5 ppm and 0-500 ppm.

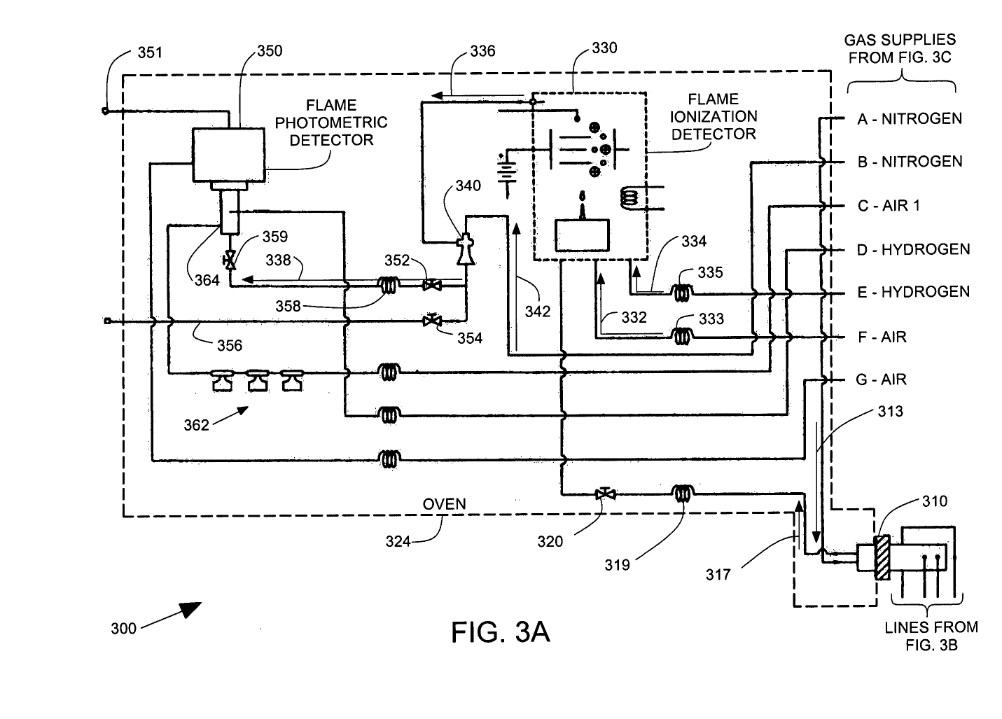

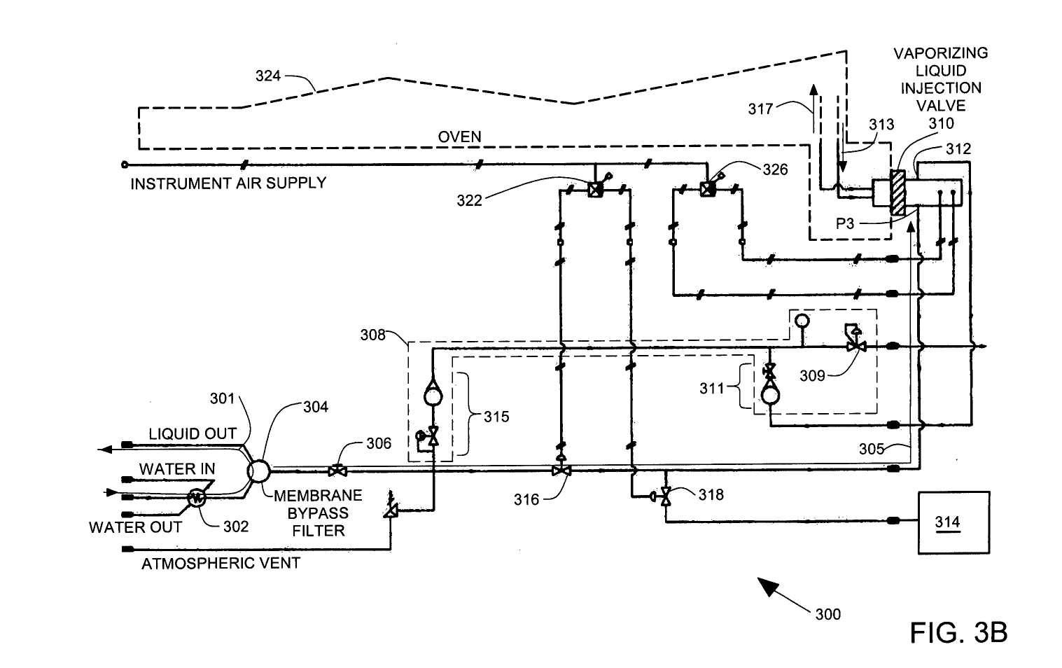

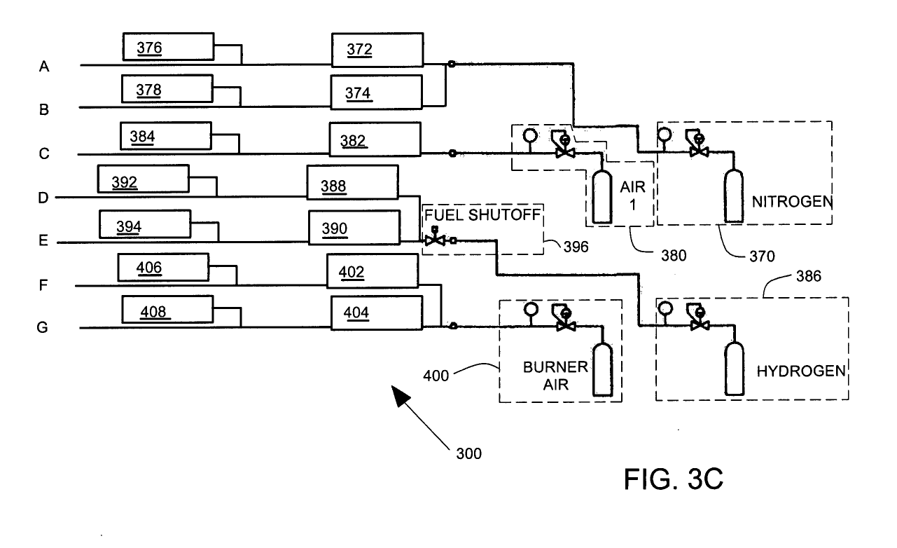

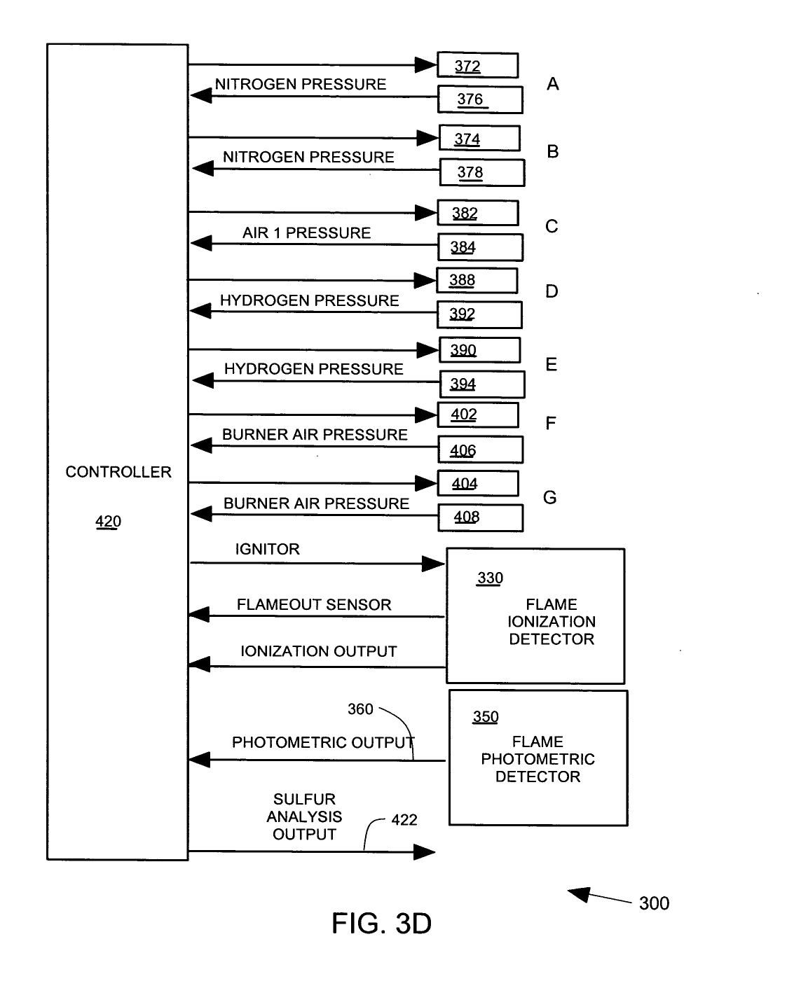

The chemical analyzer 200 is field mountable and can provide the output 260 in formats such as Communication Redundant Fieldbus, Modbus, RS-485, RS-232, Fiberoptic or wireless outputs. The chemical analyzer 200 is explained in more detail below by way of an example illustrated in FIGS. 3A, 3B, 3C.

FIGS. 3A, 3B, 3C, 3D together illustrate a third embodiment of a chemical analyzer 300. FIG. 3A illustrates an oven portion of the chemical analyzer 300. FIG. 3B illustrates a sample handling portion of the chemical analyzer 300. FIG. 3C illustrates a gas supply portion of the chemical analyzer 300. FIG. 3D illustrates a controller portion of the chemical analyzer 300.

FIGS. 3A, 3B, 3C are best understood when they are arranged with a bottom edge of FIG. 3A aligned with a top edge of FIG. 3B, and with a right side edge of FIG. 3A aligned with a left side edge of FIG. 3C. For clarity, a vaporizing liquid injection valve 310 is illustrated in both FIGS. 3A and 3B. Tubing connections between various devices are represented by solid black lines in FIGS. 3A, 3B, 3C. Tubing connections A, B, C, D, E, F, G on the right edge of FIG. 3A connect to the corresponding connections A, B, C, D, E, F, G on the left edge of FIG. 3B.

In FIG. 3B, a liquid gasoline sample 301 is circulated through a water cooler 302 and a membrane bypass filter 304. The liquid gasoline sample is received at a temperature of 40 to 400 degrees F. and a pressure of 30 to 500 PSIG pressure and a flow rate of about 0.5 gallon per minute. Water circulates through the cooler 302 to maintain a temperature at less than 250 degrees F. in the membrane bypass filter 304. A relatively high flow rate of 0.5 gallon per minute is maintained in order to reduce sensing lag time when a sulfur concentration in the liquid gasoline changes in process piping (not illustrated). Flow of the liquid gasoline sample 301 is typically maintained by connecting a liquid sample inlet to a higher pressure process connection than a liquid sample outlet connection. Alternatively, a pump (not illustrated) can be used to maintain a pressure differential needed to cause the flow of the liquid gasoline sample 301.

The membrane bypass filter 304 has a pore size of about one micron and functions as a flow restrictor to provide a lower volumetric flow rate sample flow 305 to a vaporizing liquid injection valve 310 (FIGS. 3A, 3B). While the volumetric flow rate of sample flow 305 is lower than the volumetric flow rate of the circulating liquid gasoline sample 301, it will be understood that the cross-sectional area of tubing carrying the sample flow 305 is much smaller, resulting in a high velocity to avoid excessive lag time.

The lower volumetric flow rate is controlled by regulating valve 306 and a back pressure and flow regulation system 308 connected to a sample outlet 312 of the vaporizing liquid injection valve 310. The flow regulation system 308 includes a back pressure regulator valve 309 and 10 scc per minute flow regulation valves 311, 315. A back pressure P3 is maintained at valve 310 above a bubble point pressure to ensure a bubble-free sample flow 305.

In a preferred arrangement, the analyzer can be calibrated using a pressurized liquid calibration standard 314. Valves 316, 318 can be actuated to select either the calibration standard 314 or the sample flow 305 as an input to the vaporizing liquid injection valve 310. Instrument air pressure is routed by a manually actuatable valve 322 to a pneumatic control input either valve 316 or 318. Instrument air tubes are marked by a diagonal line (/) to distinguish them from tubes carrying reagents.

The vaporizing liquid injection valve 310 also receives a supply of nitrogen flow 313 as a carrier gas. The vaporizing liquid injection valve 310 vaporizes the received sample flow 305 (or calibration standard 314). The vaporizing liquid injection valve 310 mixes vapor from the sample flow 305 (or calibration standard 314) with nitrogen and provides a gaseous sample output 317. The vaporizing liquid injection valve is preferably a dual zone valve that is maintained at about 225 degrees centigrade by an oven 324. The gaseous sample output 317 is passed through a sample capillary 319 and a regulating valve 320 and then supplied as a sample to a flame ionization detector 330. Instrument air is routed by a valve 326 to one of two instrument air lines connected to the vaporizing liquid injection valve 310. The valve 326 can be manually actuated to stop and start flow of sample output 317.

The flame ionization detector 330 (FIG. 3A) receives a supply of air 332 through a capillary 333, a supply of H₂ fuel 334 through a capillary 335, and burns the gaseous sample 317, converting the sample to a mixture of sulfur dioxide, CO₂ and H₂O at the exhaust 336 of the flame ionization detector 330. The flame ionization detector 330 is maintained at about 225 degrees C. by the oven 324. The exhaust 336 of the flame ionization detector 330 is a useful output in this application. The electrical output of the flame ionization detector 330 can be, but need not be used.

The exhaust 336 of the flame ionization detector 330, which contains sulfur dioxide, is drawn into a jet pump 340. The jet pump 340 mixes the exhaust 336 with a stream of nitrogen 342 in the jet pump 340. The mixture of nitrogen and exhaust 336 (which includes sulfur dioxide) is provided as a sample flow 338 to a flame photometric detector 350 through valve 359 and capillary 358. The jet pump 340 is controlled by a nitrogen flow through flow controller 374 (FIG. 3C) and provides a pressurized sample flow that includes N₂ gas mixed with the exhaust 336. Valves 352, 354 are provided so that the sample flow 338 can be temporarily diverted to an exhaust outlet 356 during calibration of the flame photometric detector 350. The capillary 358 and the regulating valve 359 control flow into the flame photometric detector 350.

The flame photometric detector 350 detects the sulfur dioxide in the sample flow 338. The flame photometric detector 350 provides an electrical output 360 (FIG. 3D) representative of the sulfur content of the liquid gasoline sample as inferred from the measured sulfur dioxide content in the sample flow 338. In a preferred arrangement, the flame photometric detector 350 is maintained at about 225 degrees C. by the oven 324. In a preferred embodiment, the sensitivity to sulfur dioxide of the flame photometric detector 350 is increased by providing a stream of air and RSH (mercaptans) from RSH permeation devices 362 to an air inlet 364 on the flame photometric detector 350. A cycle time for completing a measurement is less than 60 seconds. Total sulfur can be measured in ranges between 0-5 ppm and 0-500 ppm. The flame photometric detector is vented to a vent 351.

As illustrated in FIG. 3C, A supply of pressurized nitrogen 370 is coupled through flow controllers 372, 374 to tubes A, B. Pressure sensors 376, 378 sense pressures on the lines A, B. A supply of pressurized air 380 (FIG. 3C) is coupled through flow controller 382 to tube C. A pressure sensor 384 senses pressure on the line C. A supply of pressurized hydrogen fuel 386 (FIG. 3C) is coupled through flow controllers 388, 390 to tubes D, E. Pressure sensors 392, 394 sense pressures on the lines D,E. A fuel shutoff valve 396 is provided for shutting off hydrogen flow. A supply of pressurized burner air 400 (FIG. 3C) is coupled through flow controllers 402, 404 to tubes F, G. Pressure sensors 406, 408 sense pressures on the lines F, G. The flow controllers 372, 374, 382, 388, 390, 402, 404 are preferably Fluistors manufactured by Redwood Microsystems of Menlo Park, Calif. 94025. As explained below in connection with FIG. 3D, there is closed loop pressure control on fluids in lines A, B, C, D, E, F, G brought about by sensing pressure and feeding a control signal back to each flow controller.

FIG. 3D illustrates a controller 420 that is connected to various fluid handling components as illustrated. The controller 420 comprises a microcomputer, RAM, ROM and I/O. The controller 420 provides closed loop control of pressures in the tubes A, B, C, D, E, F, G in FIGS. 3A, 3C. The controller received the photometric output 360 and calculates a sulfur analysis output 422 based on calibration data stored in the controller 420. If desired, the operation of the flame ionization detector can be controlled and monitored by the controller.

The chemical analyzer 300 is field mountable and can provide the output 422 in formats such as Communication Redundant Fieldbus, Modbus, RS-485, RS-232, Fiberoptic or wireless outputs.

Although the present invention has been described with reference to preferred embodiments, workers skilled in the art will recognize that changes may be made in form and detail without departing from the spirit and scope of the invention.

1. A chemical analyzer, comprising:
a flow restrictor receiving a circulating liquid flow comprising a sulfur concentration and having a flow restrictor outlet providing a liquid sample flow that is a portion of the circulating liquid flow;
a vaporizer receiving the liquid sample flow, the vaporizer providing a vaporized sample flow that includes a portion of the liquid sample flow;
a combustion chamber receiving the vaporized sample flow and receiving supplies of air and a fuel gas, the combustion chamber providing a combustion exhaust gas in which the sulfur concentration is combusted to sulfur dioxide;
a pump receiving the combustion exhaust gas at an inlet pressure and providing pressurized combustion exhaust gas at a pressure that is higher than the inlet pressure; and
a flame photometric detector receiving the pressurized combustion exhaust gas and providing a chemical analysis output indicative of the sulfur concentration in the circulating liquid flow.

2. The chemical analyzer of claim 1 further comprising a cooler coupled to the flow restrictor.

3. The chemical analyzer of claim 1 wherein the flow restrictor comprises a membrane bypass filter.

4. The chemical analyzer of claim 3 wherein the membrane bypass filter has a pore size of about 1 micron.

5. The chemical analyzer of claim 1 wherein the vaporizer comprises a vaporizing liquid injection valve.

6. The chemical analyzer of claim 5 wherein the vaporizing liquid injection valve comprises a dual zone vaporizing liquid injection valve.

7. The chemical analyzer of claim 1 further comprising a back pressure and flow regulation system coupled to the combustion chamber.

8. The chemical analyzer of claim 1 wherein the combustion chamber comprises a flame ionization detector.

9. The chemical analyzer of claim 1 wherein the pump comprises a jet pump.

10. The chemical analyzer of claim 1 further comprising an RSH permeation device coupled to the flame photometric detector.

11. The chemical analyzer of claim 1 further comprising an oven enclosing the vaporizer and the flame photometric detector.

12. The chemical analyzer of claim 11 wherein the oven maintains a temperature of about 225 degrees Centigrade.

13. The chemical analyzer of claim 1 further comprising a flow controller controlling flow of a pressurized gas to the chemical analyzer.

14. The chemical analyzer of claim 13 further comprising a controller controlling delivery of the pressurized gas to the chemical analyzer.

15. The chemical analyzer of claim 1 further comprising a controller calculating the chemical analysis output based on calibration data stored in the controller.

16. The chemical analyzer of claim 1 wherein the circulating liquid flow comprises gasoline and the sulfur concentration in the gasoline is less than 500 ppm.

17. A method of measuring a sulfur concentration in gasoline, comprising:
receiving a circulating liquid flow of gasoline comprising a sulfur concentration;
sampling the circulating liquid flow of gasoline to provide a liquid sample flow;
vaporizing at least a portion of the liquid sample flow to provide a vaporized sample flow that includes a portion of the liquid sample flow;
combusting at least a portion of the vaporized sample flow to provide a combustion exhaust gas in which the sulfur concentration is combusted to sulfur dioxide;
pressurizing at least a portion of the combustion exhaust gas to a higher pressure;
detecting the sulfur dioxide in the pressurized combustion exhaust gas using a flame photometric detector; and
calculating an output representative of the sulfur concentration based on the sulfur dioxide detecting.

18. The method of claim 17, further comprising cooling the circulating liquid flow before the sampling.

19. The method of claim 17 and further providing an oven to maintain temperatures of the liquid sample flow, the vaporized sample flow and the combustion exhaust at a preselected temperature.

20. The method of claim 17, further comprising controlling the vaporizing, combusting and detecting with a controller.
